(19) United States
(12) Patent Application Publication
(10) Pub. No.: US 2004/0043316 A1
(43) Pub. Date: Mar. 4, 2004

(54) Image forming apparatus and toner used therein

(75) Inventors: Hiroaki Miho, Tokyo (JP); Satoshi Nishida, Tokyo (JP); Shigetaka Kurosu, Tokyo (JP); Masashi Saito, Tokyo (JP); Hiroshi Morimoto, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/632,746

(22) Filed: Aug. 1, 2003

(30) Foreign Application Priority Data
Aug. 28, 2002 (JP) 2002-248434

(51) Int. Cl. G03G 9/08; G03G 13/01; G03G 15/01

(52) U.S. Cl. 430/108.6; 430/108.7; 430/108.1; 430/45; 430/47; 399/223; 399/298

(57) ABSTRACT

According to the present invention, there is provided an image forming apparatus including developing units which develop latent images formed on image carriers for colors of yellow, magenta, cyan, and black using toners of the corresponding colors, transfer units which transfer toner images in the respective colors formed on the image carriers onto the same transfer body, and a fixing unit which fixes the toner images, and toner preferably used in the image forming apparatus. The developing unit performs development using toner in which, out of five materials of silica, titania, barium sulfate, fine polymer particles, and a lubricant, materials not including either fine polymer particles or barium sulfate are fixed as an external additive, in order to avoid poor transfer and toner filming, improve the cleaning properties, and form an excellent image.

### BACKGROUND OF THE INVENTION

1. Field of the Invention

The present invention relates to an image forming apparatus which forms an image by electrophotography and toner used in the image forming apparatus.

2. Description of the Prior Art

Currently, most of image forming apparatuses which require high speed and high image quality adopt an image forming method in accordance with an electrostatic latent image scheme including electrophotography as a predominant scheme. One of the reasons for this is that these image forming apparatuses can provide high-quality images at high speed with stability and can also be applied to the formation of color images or digital images. However, the market requests a high-level performance from an image forming technique, and thus a further improvement in performance has been demanded in an electrostatic latent image scheme as well.

There is known an image forming apparatus comprising image carriers for respective colors of yellow (Y), magenta (M), cyan (C), and black (K), developing means for developing latent images formed on the image carriers using toners of the corresponding colors primary transfer means for the respective colors for sequentially overlaying and transferring the toner images in the respective colors formed on the image carriers onto the same intermediate transfer body, a secondary transfer means for collectively transferring the overlaid toner images formed on the intermediate transfer body onto a transfer paper, and a fixing means for fixing the toner images.

There is also known an image forming apparatus comprising image carriers for the respective colors, developing means for developing latent images formed on the image carriers using toners of the corresponding colors, transfer means for the respective colors for sequentially overlaying and transferring the toner images in the respective colors formed on the image carriers onto the same transfer paper, and a fixing means for fixing the overlaid toner images formed on the transfer paper.

Additionally, toner for use in the above-mentioned image forming apparatuses is known. An external additive is fixed on the surface of the toner.

A transfer means for bringing an intermediate transfer body into contact with a photosensitive drum as an image carrier and performing transfer by pressing the photosensitive drum from inside the intermediate transfer body with a transfer roll or the like generally presses the photosensitive drum through the intermediate transfer body. It is, however, not enough to set only conditions such as pressing conditions, a difference between the linear velocity of the photosensitive drum and that of the intermediate transfer layer, and the like to prevent a poor transfer phenomenon (a phenomenon called poor transfer that a non-transfer portion appears in the center of an image) of characters and the like.

It is known that toner remaining on a photosensitive drum is removed by a cleaning blade. However, polymer toner having a small particle size is hard to scrape off. Additionally, toner of a color other than black contains a large amount of organic pigment as a colorant and is of high resistance, thereby increasing electrostatic adsorption to the photosensitive drum. Consequently, color toner is harder to scrape off than black toner. Moreover, the formation of a film of toner, i.e., toner filming is likely to occur on the surface of the photosensitive drum.

Various types of toner external additives are used. In some cases, a so-called poor transfer phenomenon described above is not resolved or the cleaning of toner remaining on an image carrier is not stably performed, even with these additives. It is therefore difficult to simultaneously achieve the prevention of poor transfer and stable cleaning of the toner remaining on the image carrier.

### SUMMARY OF THE INVENTION

The present invention has been made in consideration of the above-mentioned situations in the prior art, and has its object to provide an image forming apparatus which avoids poor transfer and toner filming and improves the cleaning properties and which can form a high-density image excellent in sharpness and the like, and toner used in the image forming apparatus.

In order to achieve the above object, according to the first aspect of the present invention, there is provided an image forming apparatus comprising image carriers for colors of yellow (Y), magenta (M), cyan (C), and black (K), developing means for developing latent images formed on the image carriers using toners of the corresponding colors, transfer means for transferring toner images in the respective colors formed on the image carriers onto the same transfer body, and fixing means for fixing the toner images, wherein the developing means performs development using toner in which, out of five materials of silica, titania, barium sulfate, fine polymer particles, and a lubricant, materials not including either the fine polymer particles or the barium sulfate are fixed as an external additive.

According to the second aspect of the present invention, there is provided an images forming apparatus wherein the transfer means according to the first aspect comprises primary transfer means for the respective colors for sequentially overlaying and transferring the toner images in the respective colors formed on the image carriers onto the same intermediate transfer body serving as a transfer body and secondary transfer means for collectively transferring the overlaid toner images formed on the intermediate body onto a transfer paper serving as another transfer body.

According to the third aspect of the present invention, there is provided an image forming apparatus wherein the transfer means according to the first aspect comprises transfer means for the respective colors for sequentially overlaying and transferring the toner images in the respective colors formed on the image carriers onto the same transfer paper as the transfer body.

In order to achieve the above object, according to the fourth aspect of the present invention, there is provided a toner used in an image forming apparatus which causes image carriers for colors of yellow (Y), magenta (M), cyan (C), and black (K) to perform development using toners of the respective colors, transfers toner images in the respective colors from the image carriers onto the same transfer body, and fixes the transferred toner images, wherein materials for an external additive which is fixed on a surface of the toner include, out of five materials of silica, titania, barium sulfate, fine polymer particles, and a lubricant, four materials not including either the fine polymer particles or the barium sulfate.

According to the fifth aspect of the present invention, there is provided atoner wherein the transfer of the toner images in the respective colors onto the transfer body according to the fourth aspect comprises primary transfer for the respective colors of sequentially overlaying and transferring the toner images in the respective colors formed on the image carriers onto the same intermediate transfer body serving as a transfer body and secondary transfer of collectively transferring the overlaid toner images formed on the intermediate transfer body onto a transfer paper serving as another transfer body.

According to the sixth aspect of the present invention, there is provided a toner wherein the transfer of the toner images in the respective colors onto the transfer body according to the fourth aspect comprises transfer for the respective colors of sequentially overlaying and transferring the toner images in the respective colors formed on the image carriers onto the same transfer paper as the transfer body.

As can be seen from the above aspects, according to the present invention, the following effects are achieved.

(1) A combination of the first and second aspects can provide an image forming apparatus capable of avoiding poor transfer and toner filming, improving the cleaning properties, and forming an excellent image. If toner which is prepared by toner polymerization to have a small uniform particle size is to be employed to improve the image quality, the cleaning properties may degrade. Additionally, if a transfer process is adopted to improve the printing speed, a poor transfer phenomenon may occur due to double transfer. With external additive compounding to the toner of the present invention, the developing properties and transfer properties are improved, and the toner attraction amount does not vary depending on the environment. In addition, poor transfer is avoided, and the cleaning properties are improved.

(2) A combination of the first and third aspects can provide an image forming apparatus capable of avoiding poor transfer and toner filming, improving the cleaning properties, and forming an excellent image. If toner which is prepared by toner polymerization to have a small uniform particle size is to be employed to improve the image quality, the cleaning properties may degrade. With external additive compounding to the toner of the present invention, the developing and transfer properties are improved, and the toner attraction amount does not vary depending on the environment. In addition, the cleaning properties are improved.

(3) A combination of the fourth and fifth aspects can provide a toner which is suitable for use in the image forming apparatus according to the first aspect and is capable of avoiding poor transfer and toner filming and improving the cleaning properties. If toner which is prepared by toner polymerization to have a small uniform particle size is to be employed to improve the image quality, the cleaning properties may degrade. Additionally, if a transfer process is adopted to improve the printing speed, a poor transfer phenomenon may occur due to double transfer. With external additive compounding to the toner of the present invention, the developing and transfer properties are improved, and the toner attraction amount does not vary depending on the environment. In addition, poor transfer is avoided, and the cleaning properties are improved.

(4) A combination of the fourth and sixth aspects can provide a toner which is suitable for use in the image forming apparatus according to the first aspect and is capable of avoiding poor transfer and toner filming and improving the cleaning properties. If toner which is prepared by toner polymerization to have a small uniform particle size is to be employed to improve the image quality, the cleaning properties may degrade. With external additive compounding to the toner of the present invention, the developing and transfer properties are improved, and the toner attraction amount does not vary depending on the environment. In addition, the cleaning properties are improved.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is sectional view showing the arrangement of an image forming apparatus according to the first embodiment of the present invention; and

FIG. 2 is a sectional view showing the main part of the arrangement of an image forming apparatus according to the second embodiment of the present invention.

### DETAILED DESCRIPTION OF THE PREFERRED EMBODIMENTS

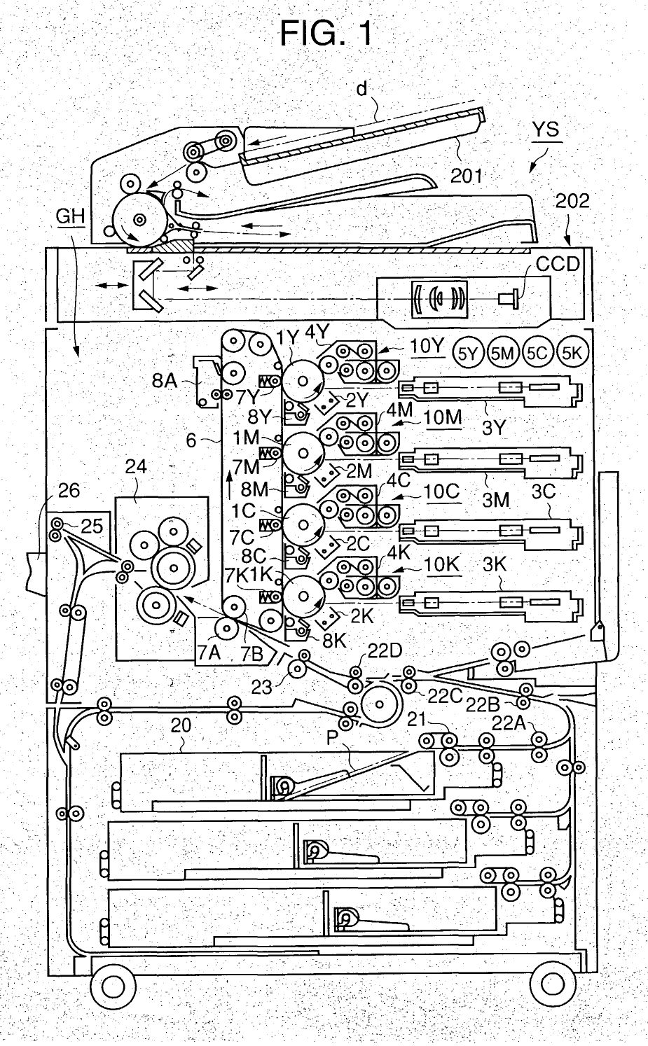

First, the arrangement of an image forming apparatus according to the first embodiment of the present invention will be described with reference to FIG. 1.

As shown in FIG. 1, an image reader YS comprising an automatic document feeder 201 and a document image scanning exposure apparatus 202 is arranged at the top of an image forming apparatus main body GH. Document sheets d placed on the document table of the automatic document feeder 201 are conveyed by a conveying means. An image of one side or images of two sides of each document sheet are scanned and exposed by the optical system of the document image scanning exposure apparatus 202 and are loaded by a line image sensor CCD.

An analog signal obtained by photoelectric conversion of the line image sensor CCD undergoes analog processing, A/D conversion, shading correction, image compression processing, and the like in an image processing section and is then sent to image exposing means 3Y, 3M, 3C, and 3K.

The automatic document feeder 201 has an automatic double-sided document convey means. The automatic document feeder 201 can read, continuously at a time, the contents of the document sheets d consisting of a large number of sheets fed from the document table and store them in a storage means. For this reason, the automatic document feeder 201 is useful in copying the contents of a large number of document sheets by a copy function, transmitting the large number of document sheets d by a facsimile function, or the like.

The image forming apparatus main body GH is referred to as a tandem-type color image forming apparatus and comprises a plurality of image forming sections 10Y, 10M, 10C, and 10K, a belt-like intermediate transfer body 6, a paper feed means, and a fixing means 24.

The image forming section 10Y for forming a yellow image comprises a charging means 2Y, an image exposing means 3Y, a developing means 4Y using toner, and a cleaning means 8Y, all of which are arranged around a photosensitive drum 1Y serving as an image carrier.

The image forming section 10M for forming a magenta image comprises a charging means 2M, an image exposing means 3M, a developing means 4M using toner, and a cleaning means 8M, all of which are arranged around a photosensitive drum 1M serving as an image carrier.

The image forming section 10C for forming a cyan image and image forming section 10K for forming a black image have the same arrangement as the image forming sections 10Y and 10M.

The charging means 2Y and image exposing means 3Y, the charging means 2M and image exposing means 3M, the charging means 2C and image exposing means 3C, and the charging means 2K and image exposing means 3K each constitute a latent image forming means. The intermediate transfer body 6, one of transfer bodies, is an endless belt. The intermediate transfer body 6 is tightly laid across a plurality of rollers and pivotally supported.

Images in the respective colors are formed by the image forming sections 10Y, 10M, 10C, and 10K and sequentially transferred onto the pivoting intermediate transfer body 6 by primary transfer rollers 7Y, 7M, 7C, and 7K serving as primary transfer means. With this operation, primary transfer is completed to form overlaid color images.

Transfer paper P serving as another transfer body which is accommodated in a paper feed cassette 20 is fed by a paper feed means 21 and passes through paper feed rollers 22A, 22B, 22C, and 22D, registration rollers 23, and the like. The transfer paper P is conveyed between a secondary transfer roller 7A serving as a secondary transfer means and a backup roller 7B, and thus the overlaid color images are transferred onto the transfer paper P. The color images on the transfer paper P are fixed by the fixing means 24, and the transfer paper P is clamped by delivery rollers 25 and placed on a delivery tray 26 outside the apparatus.

After the color images are transferred onto the transfer paper P by the secondary transfer roller 7A, the remaining toner on the intermediate transfer body 6 which has released the transfer paper P is removed by a cleaning means 8A. Note that reference numerals 5Y, 5M, 5C, and 5K denote toner replenishing means for replenishing the developing means 4Y, 4M, 4C, and 4K with toners, respectively.

### First Embodiment

The image forming apparatus according to the first embodiment of the present invention and toner used in the image forming apparatus will be described with reference to FIG. 1.

According to the gist of the present invention, there is provided an image forming apparatus comprising image carriers for respective colors of yellow (Y), magenta (M), cyan (C), and black (K), developing means for developing latent images formed on the image carriers using toners of the corresponding colors, primary transfer means for the respective colors for sequentially overlaying and transferring the toner images in the respective colors formed on the image carriers onto the same intermediate transfer body, a secondary transfer means for collectively transferring the overlaid toner images formed on the intermediate body onto a transfer paper, and fixing means for fixing the toner images. The developing means performs development using toner in which, out of five materials of silica, titania, barium sulfate, fine polymer particles, and a lubricant, four materials not including either fine polymer particles or barium sulfate are fixed as an external additive.

An external additive is a characteristic modifier to be added to toner after toner particle formation in the toner manufacturing step. According to the present invention, external additives with the following arrangements are preferably used.

The first toner contains an external additive comprising silica, titania, barium sulfate, fine polymer particles and a lubricant, and fixed on the surface of the toner. The second toner contains an external additive comprising silica, titania, barium sulfate and a lubricant, and fixed on the surface of the toner, and does not contain fine polymer particles. The third toner contains another external additive comprising silica, titania, fine polymer particles and a lubricant, and fixed on the surface of the toner, and does not contain barium sulfate. The fourth toner is either one of the first toner, second toner and third toner, in which a kind of external additive and its content are different from each other at least between black toner and toners of the colors other than black.

The main characteristics of each external additive component to be added to toner will now be described. In the present invention, reviews are repeatedly performed by repetitive experiments, and external additive components are optimally formulated.

A-silica alone controls the chargeability (Q/M). An excessive amount of A-silica increases an environmental difference in electrification, while an insufficient amount does not improve the chargeability. B-silica alone improves the transfer properties. An excessive amount of B-silica makes it difficult for the external additive to fix to the toner surface, while an insufficient amount degrades the transfer properties.

A-titania alone improves the fluidity. An excessive amount of a-titania inhibits electrification and degrades the repetition stability, while an insufficient amount degrades the fluidity. B-titania alone controls electrification. An excessive amount of b-titania is likely to move charges from the toner surface to the carrier side, thereby degrading the toner chargeability. On the other hand, an insufficient amount is likely to overcharge the toner surface.

Barium sulfate or fine polymer particles alone form a sandwiched layer at the tip of a cleaning blade to facilitate cleaning. An excessive amount of barium sulfate or fine polymer particles inhibits electrification or promotes toner scattering, while an insufficient amount inhibits the formation of a sandwiched layer.

The characteristics of a lubricant will be described. A film of the lubricant is formed on the surface of a photosensitive drum serving as an image carrier. This causes the surface energy of the photosensitive drum to fall below that of an intermediate transfer body, thereby inhibiting a so-called poor transfer phenomenon. The low surface energy of the photosensitive drum also facilitates toner scraping. Excessive surface energy is likely to cause filming (formation of a film made of, e.g., toner on the surface of the image carrier) on the surface of the photosensitive drum, while insufficient surface energy inhibits the formation of a lubricant film.

With the above-mentioned optimal compounding of an external additive, poor transfer and toner filming are avoided. Poor compounding is likely to cause either of poor transfer and toner filming.

In the developing means, black toner and toners of the colors other than black are different in external additive type and its content for the following reason. Since toner of a color other than black uses a large amount of organic pigment as a colorant, the resistance of the toner increases, thus resulting in an increase in electrostatic attraction force to the photosensitive drum. Accordingly, if the remaining toner is of a color other than black, it is more difficult to scrape off by a cleaning blade than the case of the black toner. If the black toner and toners of the colors other than black are the same, the abrasive wear amount, of the photosensitive drum for the black toner, by the cleaning blade is likely to increase.

When barium sulfate is to be employed in the compounding of a toner external additive according to the present invention the content of barium sulfate preferably falls within 0.1 to 1 mass % with reference to the mass of toner. Similarly, if fine polymer particles are to be employed, the content of fine polymer particles preferably falls within 0.1 to 0.5 mass % with reference to the toner mass. If a lubricant is to be employed the content of the lubricant preferably falls within 0 to 0.4 mass % with reference to the toner mass. If the toner external additive is formulated such that the components fall within the above-mentioned ranges, so-called poor transfer and toner filming are avoided. Otherwise, either of poor transfer and toner filming is likely to occur.

When silica is to be employed in the compounding of the toner external additive according to the present invention, the silica preferably comprises two kinds of silicas having different particle sizes, i.e., A-silica and B-silica. A-silica controls electrification, and B-silica improves the transfer properties. By using both of them, poor transfer and toner filming are avoided. However, if only one of them is to be used, either of poor transfer and toner filming is likely to occur.

When A-silica is to be employed in the compounding of the external additive according to the present invention, preferably, the particle size of A-silica falls within 10 to 30 nm, and its content falls within 0.1 to 0.3 mass % with reference to the toner mass. Similarly when B-silica is to be employed, preferably, the particle size of B-silica falls within 20 to 100 nm, and its content falls within 0.5 to 1.5 mass % with reference to the toner mass. If the external additive is formulated such that the components fall within the above-mentioned ranges, so-called poor transfer and toner filming are avoided. Otherwise, either of poor transfer and toner filming is likely to occur.

When titania is to be employed in the compounding of the toner external additive according to the present invention, the titania preferably comprises two kinds of titanias having different particle sizes, i.e., a-titania and b-titania. A-titania improves the fluidity, and b-titania controls electrification. By using both of them, poor transfer and toner filming are avoided. However, if only one of them is to be used, either of poor transfer and toner filming is likely to occur. If a-titania is to be employed, preferably, the particle size of a-titania falls within 10 to 30 nm, and its content falls within 0.1 to 0.7 mass % with reference to the toner mass. When b-titania is to be employed in the compounding of the toner external additive according to the present invention, preferably, the particle size of b-titania falls within 50 to 200 nm, and its content falls within 0.1 to 0.5 mass % with reference to the toner mass. If the toner external additive is formulated such that the components fall within the above-mentioned ranges, so-called poor transfer and toner filming are avoided. Otherwise, either of poor transfer and toner filming is likely to occur.

If toner which is prepared by polymerization to have a small uniform particle size is to be employed to improve the image quality, the cleaning properties may degrade. Additionally, assume that intermediate transfer process is adopted to increase the printing speed. In this case, the transfer process is performed twice in total, and thus a poor transfer phenomenon may occur. With the above-mentioned external additive compounding, these problems can be solved.

The number average particle size of an external additive is observed with a transmission electron microscope and measured by image analysis, and the measurement result is displayed.

Assume that the particle size of each external additive component falls below the lower limit. In this case, since the physical attraction force between toner and a corresponding image carrier does not weaken, the transfer properties degrade, thus resulting in a decrease in image density. On the other hand, assume that the particle size exceeds the upper limit. In this case, external additive particles are easily liberated from attracted toner due to stress caused by stirring and the like in the developing means, and thus free external additive particles accumulate and re-aggregate in the developing means. A large amount of particles form the core to cause a poor transfer phenomenon and are liberated from the toner at the time of transfer. Since the particles are attracted to the surface of the image carrier, filming on the image carrier surface is likely to occur.

The use of toner having a number average particle size of 3 to 8 μm provides the developing means with a high resolution and enables formation of images of an image quality excellent in sharpness. The number average particle size is more preferably 4 to 6 μm. If the number average particle size falls within this range, the number of toner particles with a strong attraction force which fly to a heating member to cause offsetting decreases in the fixing step. The transfer efficiency increases, and the quality of halftone images increases, thus resulting in an increase in image quality of fine lines, dots, and the like. Assume that the number average particle size is less than 3 μm. In this case, electrification is not sufficiently performed, and toner scattering may cause a decrease in image quality and may adversely affect human bodies. Additionally, the production efficiency may degrade. On the other hand, assume that the number average particle size exceeds 8 μm. When toner scatters around characters, the scatter becomes so prominent that it can easily be recognized by visual observation.

The developing means preferably performs development by using a two-component developing agent mainly composed of toner and carrier. A metal material such as iron, ferrite, magnetite, or the like is used as magnetic particles of the carrier. Preferably, the carrier is formed by further coating magnetic particles with resin or is a resin-dispersed type carrier in which magnetic particles are dispersed in resin. The resin composition for coating is not specifically limited. For example, an olefin-, styrene-, or styrene-acryl-based resin is employed. A resin constituting the resin-dispersed type carrier is not specifically limited and any resin known in the art maybe employed. For example, a styrene-acrylic resin, polyester resin, or the like may be employed.

The use of toner manufactured by polymerization can provide a sharp and high-density image quality. Additionally, polymerization improves the manufacturability. Since this type of toner (also referred to as polymer toner) has a uniform composition and a uniform particle size, it is easily mixed with carrier on a developing agent carrier and is uniformly charged in a short period of time. This type of toner is thus preferable. A method for preparing polymer toner will be described. However, the present invention is not limited to this preparation method. Polymer toner cane be manufactured by the following process. Resin particles having a number average primary particle size of 10 to 500 nm, which are prepared by suspension polymerization or emulsion polymerization, are subjected to salting-out/fusing to produce secondary particles. An organic solvent, coagulant, polymerization catalyst, and the like are then added to the secondary particles to perform polymerization. When the rate of polymerization reaches 80%, the polymerization catalyst is further added to the spherical secondary particles (spherical toner) in the solution to complete the polymerization. Carbon black, a dye, a pigment, or the like may arbitrarily be employed as a colorant used for the polymer toner. As Carbon black, for example, channel black, firness black, acetylene black, thermal black, lamp black, or the like is used.

Assume that the intermediate transfer body comprises an endless belt having a resistivity of 1×10⁴ to 1×10¹³ Ω·cm, the secondary transfer roller has a resistance of 1×10⁵ to 1×10¹⁰ Ω, and the backup roller serving as a backup member which presses the intermediate transfer body has a resistance of 1×10⁵ to 1×10¹⁰ Ω. In this case, transfer is performed without any toner scatter in an image, thereby achieving a high image quality.

Toner number particle size distribution, toner number average particle size, and a coefficient of variation in toner number particle size distribution will be described below.

Toner number particle size distribution represents the relative frequency of a toner particle relative to a particle size. Assume that the size of toner particles is D (μm). In a number-based histogram which shows a number-based particle size distribution natural logarithm lnD is taken as the abscissa and the abscissa is divided into a plurality of classes at an interval of 0.23. The toner number particle size distribution is a ratio (%) of the sum (M) of the relative frequency (m1) of toner particles included in the highest-frequency class and the relative frequency (m2) of toner particles included in the second-highest-frequency class .

Number average particle size (Dn) represents an average diameter in the toner number particle size distribution.

Number variation coefficient in toner number particle size distribution (also referred to as a number variation coefficient of toner) is calculated by toner number variation coefficient=(S/Dn)×100 (%), where S represents the standard deviation in toner number particle size distribution, and Dn represents a toner number average particle size (μm). The toner number variation coefficient falls within 15 to 22%. When the toner number variation coefficient falls within this range, voids of a transferred toner layer decrease, and the charge amount distribution is narrowed. This increases the transfer efficiency.

Image formation of a document by the image forming apparatus according to the first embodiment will be described with reference to FIG. 1.

First, the document sheets d are read as image data by the document image scanning exposure means 202. Digital exposure is performed for the photosensitive drums 1Y, 1M, 1C, and 1K based on this image data to form latent images on the respective photosensitive drums. Each latent image formed on each photosensitive drum is developed using any corresponding one of the first to fourth toners. Toner images are sequentially overlaid and transferred onto the intermediate transfer body 6, which is common to the four colors. The case of yellow will be explained by way of example. A toner image of the photosensitive drum 1Y is transferred onto the intermediate transfer body 6 due to voltage application to the primary transfer roller 7Y.

A current value of the secondary transfer roller 7A as the secondary transfer means is then selected, and voltage is applied to the secondary transfer roller 7A. Overlaid toner images are collectively transferred from the intermediate transfer body 6 onto the transfer paper P, and the overlaid toner images on the transfer paper P are fixed. With this operation, a printed image can be obtained.

With the above-mentioned arrangement, in the image forming apparatus, poor transfer and toner filming are avoided, and the cleaning properties are improved. The image forming apparatus can form a high-density image excellent in sharpness, and the like. If toner which is prepared by toner polymerization to have a small uniform particle size is to be employed, the cleaning properties may degrade. Additionally, if a transfer process is adopted to improve the printing speed, a poor transfer phenomenon may occur due to double transfer. With the toner external additive compounding of the present invention, the developing and transfer properties are improved, and the toner attraction amount does not vary depending on the environment. In addition, poor transfer is avoided, and the cleaning properties are improved. The toner is optimal for use in the image forming apparatus.

### Second Embodiment

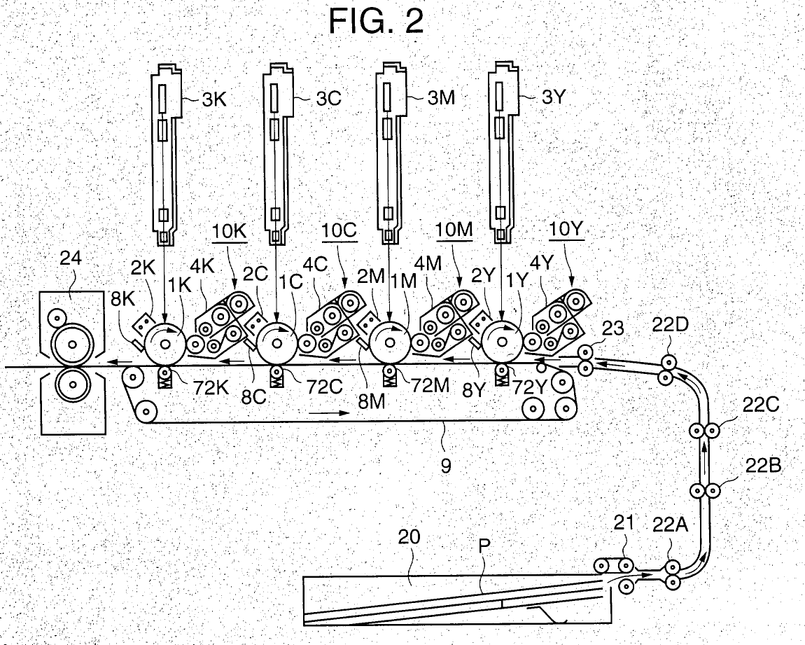

An image forming apparatus according to the second embodiment of the present invention and toner used therein will be described with reference to FIG. 2.

FIG. 2 is a sectional view showing the arrangement of the main part of the image forming apparatus according to the second embodiment of the present invention. A description of the structurally same parts as the first embodiment will partly be omitted. Toner to be used in the second embodiment is the same as in the first embodiment, and a description thereof will be omitted.

In FIG. 2, an image forming section 10Y for forming a yellow image comprises a charging means 2Y, an image exposing means 3Y, a developing means 4Y using toner, and a cleaning means 8Y arranged around a photosensitive drum 1Y. An image forming section 10M for forming magenta image comprises a photosensitive drum 1M serving as an image carrier, a charging means 2M, an image exposing means 3M, a toner developing means 4M, and a cleaning means 8M. An image forming section 10C for forming a cyan image and an image forming section 10K for forming a black image have the same arrangement as the image forming sections 10Y and 10M. The charging means 2Y and image exposing means 3Y, the charging means 2M and image exposing means 3M, the charging means 2C and image exposing means 3C, and the charging means 2K and image exposing means 3K constitute latent image forming means.

Transfer paper P serving as a transfer body which is accommodated in a paper feed cassette 20 is fed by a paper feed means 21 and passes through paper feed rollers 22A, 22B, 22C, and 22D, and registration rollers 23.

Toner images in the respective colors are formed on the photosensitive drums 1Y, 1M, 1C, and 1K serving as the image carriers by the image forming sections 10Y, 10M, 10C, and 10K and sequentially transferred by transfer rollers 72Y, 72M, 72C, and 72K serving as transfer means onto the transfer paper P, which is conveyed on a pivoting transfer belt 9 in the direction of an arrow. With this operation, the toner images in the respective colors are overlaid to form a color image on the transfer paper P.

According to the gist of the present invention, there is provided an image forming apparatus comprising image carriers for respective colors of yellow (Y), magenta (M), cyan (C), and black (K), developing means for developing latent images formed on the image carriers using toners of the corresponding colors, transfer means for the respective colors for sequentially overlaying and transferring the toner images in the respective colors formed on the image carriers onto the same transfer paper, and fixing means for fixing the overlaid toner images on the transfer paper. The developing means performs development using toner in which, out of five materials of silica, titania, barium sulfate, fine polymer particles, and a lubricant, four materials not including either fine polymer particles or barium sulfate are fixed as an external additive.

Image formation of a document by the image forming apparatus will be described mainly with reference to FIG. 2 and partially with reference to FIG. 1.

First, the image data of a document is read by the document image scanning exposure means shown in FIG. 1. Digital exposure is performed for the photosensitive drums 1Y, 1M, 1C, and 1K by the image exposing means 3Y, 3M, 3C, and 3K to form latent images on the respective photosensitive drums. A voltage is then applied to the transfer rollers 72Y, 72M, 72C, and 72K serving as transfer means for the respective colors. As described in the first embodiment, each of the latent images formed on the photosensitive drums 1Y, 1M, 1C, and 1K is developed by a corresponding one of the developing means 4Y, 4M, 4C, and 4K using any corresponding one of the first to fourth toners. Toner images are sequentially overlaid and transferred onto the transfer paper P. The overlaid toner images are fixed by a fixing means 24 to form a color image.

With the above-mentioned arrangement, in the image forming apparatus, poor transfer and toner filming are avoided, and the cleaning properties are improved. The image forming apparatus can form a high-density image excellent in sharpness, and the like. The toner is optimal for use in the image forming apparatus. If toner which is prepared by toner polymerization to have a small uniform particle size is to be employed to improve the image quality, the cleaning properties may degrade. With the toner external additive compounding of the present invention, the developing and transfer properties are improved, and the toner attraction amount does not vary depending on the environment. In addition, the cleaning properties are improved.

### Experimental Example

An experimental example of the present invention will be described below. However, the present invention is not limited to the example.

### Image Forming Apparatus and Sample of Developing Agent

Image formation was performed using the image forming apparatus shown in FIG. 1 under the following conditions.

Each photosensitive drum: The photosensitive drum had an outer diameter of 60 mm and employed an organic semiconductor layer to which a phthalocyanine pigment dispersed in polycarbonate was applied. The thickness of the photosensitive body layer including a charge transport layer was 25 μm. The potential of the non-image portion of each photosensitive drum was detected by a potential sensor and subjected to feedback control (controllable range is from −500 V to −900 V). The total exposure potential was set to −50 V to 0 V.

Linear velocity of each photosensitive drum: 220 mm/sec

Exposure: Exposure was performed according to a laser scanning scheme using a semiconductor laser whose output power was set to 300 μm.

Primary transfer means: The conductive foam primary transfer rollers 7Y, 7M, 7C, and 7K were mounted on the rear surface of the intermediate transfer body 6.

Pressing force of primary transfer roller (primary transfer means): a pressing force of 4.9 N

Primary transfer roller (primary transfer means): The primary transfer roller had an outer diameter of 20 mm and a resistance of 1×10⁷ Ω.

Current in constant current control: 25 μA

Resistivity of intermediate transfer body: 1×10⁸ Ωcm

Tension of belt serving as intermediate transfer body at the time of application of 500 V: 49N

Load of cleaning blade: 20 g/cm

Fixing: Fixing was performed by a roller incorporating a heater.

Toner replenishment apparatus: The toner replenishment apparatus replenished a developing agent carrier with toner.

Samples of developing agent: The samples were as follows.

As the first toner sample, toner prepared in accordance with the following external additive formulation A was used.

In the formulation A, the content of A-silica was 0.2 mass %, the content of B-silica was 0.5 mass %, the content of a-titania was 0.4 mass %, the content of b-titania was 0.4 mass %, the content of barium sulfate was 0.5 mass %, and the content of a lubricant (calcium stearate) was 0.2 mass %.

As the second toner sample, toner prepared in accordance with the following external additive formulation B was used.

In the formulation B, the content of A-silica was 0.2 mass %, the content of B-silica was 0.5 mass %, the content of a-titania was 0.4 mass %, the content of b-titania was 0.4 mass %, the content of fine polymer particles was 0.5 mass %, and the content of a lubricant (calcium stearate) was 0.2 mass %.

As the third toner sample, toner prepared in accordance with the following external additive formulation C was used.

In the formulation C, the content of A-silica was 0.2 mass %, the content of B-silica was 0.5 mass %, the content of a-titania was 0.4 mass %, the content of b-titania was 0.4 mass %, the content of fine polymer particles was 0.2 mass %, the content of barium sulfate was 0.3 mass %, and the content of a lubricant (calcium stearate) was 0.2 mass %.

As a black sample using the fourth toner, toner prepared in accordance with the following external additive formulation D was used.

In the formulation D, the content of A-silica was 0.2 mass %, the content of B-silica was 0.8 mass %, the content of a-titania was 0.4 mass %, the content of b-titania was 0.1 mass %, the content of fine polymer particles was 0.2 mass %, and the content of a lubricant (zinc stearate) was 0.15 mass %. As toners of the colors other than black, i.e., yellow, magenta, and cyan toners, ones prepared in accordance with the above-mentioned external additive formulation A were used.

As the first comparative sample, toner prepared in accordance with a toner external additive formulation E obtained by excluding the lubricant from the toner external additive formulation A was used. As the second comparative sample, toner prepared in accordance with a toner external additive formulation F obtained by excluding barium sulfate from the toner external additive formulation A was used.

### Measuring Method

To measure a poor transfer phenomenon, a chart with 100 dots on it was visually observed to count the number of dots, each of which exhibits a poor transfer phenomenon.

To measure the cleaning properties, a process of cleaning a photosensitive drum with an A4-size solid toner image (toner attraction amount: 0.5 mg/cm²) without transfer was continuously repeated ten times. The remaining toner state was visually observed on the photosensitive drum. After an A4-size solid toner image (toner attraction amount: 0.5 mg/cm²) was transferred onto a belt (intermediate transfer body) in primary transfer, a process of cleaning the belt without secondary transfer was continuously repeated ten times. The toner remaining state was visually observed on the belt.

To measure the durability using an investigation chart, a chart which included both characters and photographs and had a printing ratio of 10% was used.

### Experimental Result

Image formation is performed under the above-mentioned conditions, and 100,000 copies were made. As a result, according to toner using an external additive formulation of the present invention, no poor transfer phenomenon occurred, the cleaning properties were excellent, and no fogging or scumming due to toner filming occurred. Every copy had a high density and showed a sharp excellent image.

In black toner, the contents of barium sulfate and fine polymer particles as abrasives were reduced. For this reason, the load of a cleaning blade which removes remaining toner on the photosensitive drum could be reduced. The abrasive wear amount of the photosensitive drum was as small as 0.2 μm with respect to a slide distance of 10 km.

Note that in the case of the first comparative sample, a poor transfer phenomenon started to occur at the 1,000th copy, and a cleaning failure occurred at the 10,000th copy. In the case of toner using the external additive of the second comparative sample, no poor transfer phenomenon occurred. However, fogging and scumming due to toner filming occurred at the 20,000th copy.

What is claimed is:

1. An image forming apparatus comprising image carriers for colors of yellow (Y), magenta (M), cyan (C), and black (K), developing means for developing latent images formed on the image carriers using toners of the corresponding colors, transfer means for transferring toner images in the respective colors formed on the image carriers onto the same transfer body, and fixing means for fixing the toner images,
wherein the developing means performs developments using toner in which, out of five materials of silica, titania, barium sulfate, fine polymer particles, and a lubricant, materials not including either the fine polymer particles or the barium sulfate are fixed as an external additive.

2. An apparatus according to claim 1, wherein the transfer means comprises primary transfer means for the respective colors for sequentially overlaying and transferring the toner images in the respective colors formed on the image carriers onto the same intermediate transfer body serving as a transfer body and secondary transfer means for collectively transferring the overlaid toner images formed on the intermediate body onto a transfer paper serving as another transfer body.

3. An apparatus according to claim 1, wherein the transfer means comprises transfer means for the respective colors for sequentially overlaying and transferring the toner images in the respective colors formed on the image carriers onto the same transfer paper as the transfer body.

4. An apparatus according to claim 1, wherein the developing means performs development using a black toner and toners of colors other than black which contain at least two types of external additives different in component type and content.

5. An apparatus according to claim 1, wherein a content of the barium sulfate is 0.1 to 1 mass %, a content of the fine polymer particles is 0.1 to 0.5 mass %, and a content of the lubricant is 0 to 0.4 mass %.

6. An apparatus according to claim 1, wherein the silica includes A-silica and B-silica, two types of silica having different particle sizes.

7. An apparatus according to claim 6, wherein the A-silica has a particle size of 10 to 30 nm, a content of the A-silica is 0.1 to 0.3 mass %, the B-silica has a particle size of 20 to 100 nm, and a content of the B-silica is 0.5 to 1.5 mass %.

8. An apparatus according to claim 1, wherein the titania includes a-titania and b-titania, two types of titania having different particle sizes.

9. An apparatus according to claim 8, wherein the a-titania has a particle size of 10 to 30 nm, a content of the a-titania is 0.1 to 0.7 mass %, the b-titania has a particle size of 50 to 200 nm, and a content of the b-titania is 0.1 to 0.5 mass %.

10. An apparatus according to claim 1, wherein the toners used in the developing means have a number average particle size of 3 to 8 μm.

11. An apparatus according to claim 1, wherein the developing means performs development using a two-component developing agent mainly composed of toner and carrier, and the toner is manufactured by polymerization.

12. An apparatus according to claim 1, wherein the intermediate transfer body comprises an endless belt which has a resistivity of 1×10⁴ to 1×10¹³ Ωcm.

13. An apparatus according to claim 1, wherein the secondary transfer means includes a secondary transfer roller, the secondary transfer roller has a resistance of 1×10⁵ to 1×10¹⁰ Ω, the intermediate transfer body includes an endless belt, and the intermediate transfer body has a resistivity of 1×10⁴ to 1×10¹³ Ωcm.

14. An apparatus according to claim 13, wherein a backup member which presses the intermediate transfer body against the secondary transfer roller has a resistance of 1×10⁵ to 1×10¹⁰ Ω.

15. A toner used in an image forming apparatus which causes image carriers for colors of yellow (Y), magenta (M), cyan (C), and black (K) to perform development using toners of the respective colors, transferring toner images in the respective colors from the image carriers onto the same transfer body, and fixes the transferred toner images, wherein materials for an external additive which is fixed on a surface of the toner includes, out of five materials of silica, titania, barium sulfate, fine polymer particles, and a lubricant, four materials not including either the fine polymer particles or the barium sulfate.

16. A toner according to claim 15, wherein the transfer of the toner images in the respective colors onto the transfer body comprises primary transfer for the respective colors of sequentially overlaying and transferring the toner images in the respective colors formed on the image carriers onto the same intermediate transfer body serving as a transfer body and secondary transfer of collectively transferring the overlaid toner images formed on the intermediate transfer body onto a transfer paper serving as another transfer body.

17. A toner according to claim 15, wherein the transfer of the toner images in the respective colors onto the transfer body comprises transfer for the respective colors of sequentially overlaying and transferring the toner images in the respective colors formed on the image carriers onto the same transfer paper as the transfer body.

18. A toner according to claim 15, wherein the toner comprise a black toner and toners other than the black toner which contain at least two types of external additives different in component type and content.

19. A toner according to claim 15, wherein a content of the barium sulfate is 0.1 to 1 mass %, a content of the fine polymer particles is 0.1 to 0.5 mass %, and a content of the lubricant is 0 to 0.4 mass %.

20. A toner according to claim 15, wherein the silica includes A-silica and B-silica, two types of silica having different particle sizes.

21. A toner according to claim 20, wherein the A-silica has a particle size of 10 to 30 nm, a content of the A-silica is 0.1 to 0.3 mass %, the B-silica has a particle size of 20 to 100 nm, and a content of the B-silica is 0.5 to 1.5 mass %.

22. A toner according to claim 15, wherein the titania includes a-titania and b-titania, two types of titania having different particle sizes.

23. A toner according to claim 22, wherein the a-titania has a particle size of 10 to 30 nm, a content of the a-titania is 0.1 to 0.7 mass %, the b-titania has a particle size of 50 to 200 nm, and a content of the b-titania is 0.1 to 0.5 mass %.

24. A toner according to claim 15, characterized by having a number average particle size of 3 to 8 μm.

25. A toner according to claim 15, wherein the toners of the respective colors are manufactured by polymerization.
